(19) United States
(12) Patent Application Publication
(10) Pub. No.: US 2015/0009076 A1
(43) Pub. Date: Jan. 8, 2015

(54) PORTABLE ELECTRONIC DEVICE WITH ANTENNA DEVICE

(71) Applicant: Samsung Electronics Co., Ltd., Gyeonggi-do (KR)

(72) Inventor: Si-Young JANG, Gyeongsangbuk-do (KR)

(73) Assignee: Samsung Electronics Co., Ltd., Gyeonggi-do (KR)

(21) Appl. No.: 14/265,903

(22) Filed: Apr. 30, 2014

(30) Foreign Application Priority Data
Jul. 3, 2013 (KR) 10-2013-0077510

(51) Int. Cl. H01Q 1/24

(52) U.S. Cl. CPC H01Q 1/243
USPC 343/702

(57) ABSTRACT

A portable electronic device is provided which includes a first housing; a second housing that is coupled to the first housing; at least one pair of antenna elements that are housed in the first housing; and a switch element that connects the antenna elements to a transmission/reception circuit module. The switch element connects a first antenna element to the transmission/reception circuit module when the first and second housings are folded and connects a second antenna element to the transmission/reception circuit module when the second housing is unfolded.

### PRIORITY

This application claims priority under 35 U.S.C. § 119(a) to Korean Application Serial No. 10-2013-0077510, which was filed in the Korean Intellectual Property Office on Jul. 3, 2013, the entire content of which is incorporated herein by reference.

### BACKGROUND OF THE INVENTION

1. Field of the Invention

The present invention generally relates to an electronic device, and more particularly, to a portable electronic device which is provided with an antenna device to be capable of performing wireless transmission/reception.

2. Description of the Related Art

Typically, a portable electronic device refers to a device which allows a user to use a communication function such as voice communication or short message transmission, a multimedia function such as reproducing music or a moving picture, and an entertainment function such as a game while carrying the device. Such portable electronic devices are configured in various types in consideration of individually specified functions and portability thereof, and classified into, for example, bar-type, folder-type and sliding-type electronic devices according to the external appearances. Furthermore, while a Personal Computer (PC) usually refers to a desktop computer which may be used in homes and offices, laptop computers have been maximized in portability and space usability in general use environments including homes and offices and are rapidly supplanting desktop computers.

Among these portable electronic devices, some electronic devices are able to substantially freely access available wireless communication networks similarly to mobile communication terminals. However, some of the portable electronic devices such as portable multimedia players or laptop computers are capable of only limited wireless communication. The devices capable of only limited wireless communication like laptop computers may access available communication networks by accessing a wireless Access Point (AP) provided within a limited area like a wireless Local Area Network (LAN) or by sharing an available communication network accessing function of a mobile communication terminal. In the mobile communication environment, users generally use portable electronic devices such as mobile communication terminals or tablet PCs which are convenient to carry. In general, the performances of mobile communication terminals and PCs have improved and are coming close to the performances of personal computers. Personal computers such as laptop computers are now being manufactured with reduced thickness and weight so as to maximize the portability thereof while providing sufficiently large input/output devices such as a key board and a display device.

Accordingly, some portable electronic devices, which have been provided with only limited wireless communication functions like laptop computers, are now equipped with an antenna device which is capable of being connected to the available communication networks. In the case of a laptop computer, usability is secured, for example, by being provided with a key board so as to enable more convenient input, and a configuration in which a first housing provided with the key board and a second housing provided with a display device are foldably coupled to each other is generally employed. Such a configuration of the laptop computer makes it possible to secure portability while allowing a large amount of information to be conveniently input.

When accessing the available wireless communication networks using the laptop computer as described above, in general, the connection state is normally maintained so as to receive a call or the like. However, in a portable electronic device which is foldably configured like the laptop computer, considerable deviation occurs in radiation performance of the antenna device depending on whether the housings are in the folded state or in the unfolded state. Accordingly, there is a need to secure an antenna device which may stably maintain a normal connection state to an available wireless communication network.

### SUMMARY OF THE INVENTION

The present invention has been made to address at least the above problems and disadvantages, and to provide at least the advantages described below.

Accordingly, an aspect of the present invention is to provide a portable electronic device which is provided with an antenna device capable of maintaining a stable connection state with a communication network.

Another aspect of the present invention is to provide a portable electronic device which is provided with an antenna device capable of maintaining a stable connection state with a communication network even if the housings of the portable electronic device undergoes a change in shape, for example, by being folded or slid in relation to each other.

According to the aspects of the present invention, there is provided a portable electronic device including a first housing; a second housing that is coupled to the first housing; at least one pair of antenna elements that are housed in the first housing; and a switch element that connects the antenna elements to a transmission/reception circuit module, the switch element connecting a first antenna element to the transmission/reception circuit module when the first and second housings are folded on each other, and connecting a second antenna element to the transmission/reception circuit module when the second housing is unfolded from the first housing.

According to another aspect of the present invention, there is provided a portable electronic device including a first housing; a second housing that is coupled to the first housing; at least one pair of antenna elements that are housed in the first housing; and a switch element that connects the antenna elements to a transmission/reception circuit module, the switch element connecting a first antenna element to the transmission/reception circuit module when the first and second housings are located on top of each other, and connecting a second antenna element to the transmission/reception circuit module when the second housing is not located on top of the first housing.

According to another aspect of the present invention, there is provided a portable electronic device including a first housing; a second housing that is slidably coupled to the first housing; at least one pair of antenna elements that are housed in the first housing; and a switch element that connects the antenna elements to a transmission/reception circuit module, the switch element connecting a first antenna element to the transmission/reception circuit module when the first and second housings are located on top of each other, and connecting a second antenna element to the transmission/reception circuit module when the second housing is slid away from the first housing.

### BRIEF DESCRIPTION OF THE DRAWINGS

The above and other aspects, features, and advantages of the present invention will be more apparent from the following detailed description taken in conjunction with the accompanying drawings, in which:

FIG. 1 is an exploded perspective view illustrating a portable electronic device according to an embodiment of the present invention;

FIG. 2 is a cross-sectional view illustrating a part of the portable electronic device illustrated in FIG. 1; and

FIG. 3 is a schematic view illustrating antenna elements of the portable electronic device illustrated in FIG. 1.

### DETAILED DESCRIPTION OF EMBODIMENTS OF THE PRESENT INVENTION

Hereinafter, various embodiments of the present invention will be described with reference to the accompanying drawings. For clarity and simplicity, a detailed description of known functions and configurations incorporated herein will be omitted as it may make the subject matter of the present invention rather unclear.

The present invention may be applied to any portable electronic device, such as a laptop computer, mobile terminal, etc., having a pair of housings connected to each other.

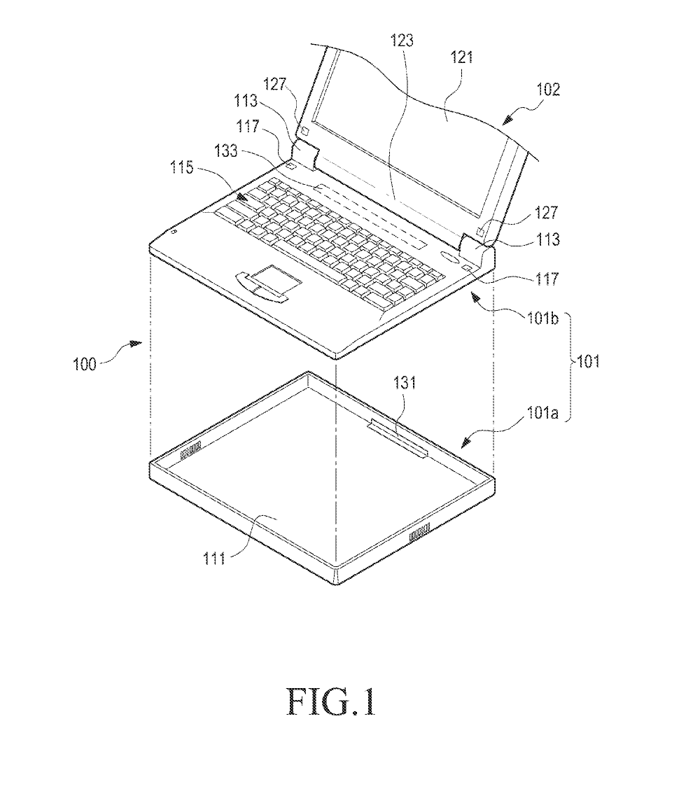

As illustrated in FIGS. 1 to 3, the portable electronic device 100 according to an embodiment of the present invention has a configuration in which a pair of housings 101 and 102 are pivotally coupled to each other and is provided with at least one pair of antenna elements 131 and 133 housed within one of the housings 101 and 102. As seen in FIG. 3, a switch element 137 is disposed between a transmission/reception circuit module 139 of the portable electronic device 100 and the antenna elements 131 and 133. The switch element 137 connects one of the antenna elements selected from the antenna elements 131 and 133 to the transmission/reception circuit module 139 according to the opening/closing operation of the housings 101 and 102.

In the housings, a first housing 101 is configured by assembling a front case 101b and a rear case 101a. The rear case 101a provides an accommodation space 111 of which the front side is opened and is formed with a plurality of openings in the lateral sides thereof so that heat generated in the inside of the first housing 101 can dissipate. In the accommodation space 111, for example, a main circuit board, a battery pack and a sound input/output device (not illustrated) are installed. The front case 101b is coupled to the rear case 101a to close the front side of the accommodation space 111 and may be provided with an input device 115 exposed to the outside, such as a key board or a touch pad.

In the housings, a second housing 102 is pivotally coupled to the first housing 101 and provided with a display panel 121. Since the second housing 102 is pivotally coupled to the first housing 101, a user may use the portable electronic device 100 by pivoting the second housing 102 folded to the first housing 101 so that the second housing 102 is unfolded by a desired angle. In the state where the second housing 102 is folded to the first housing 101, both the display panel 121 and the input device 115 are closed. The second housing 102 may alternately be slidably coupled to housing 101.

In order to couple the first and second housings 101 and 102 to be pivotable in relation to each other, the portable electronic device 100 is provided with a hinge device. The hinge device includes a pair of side hinge arms 113 provided on the first housing 101, a center hinge arm 123 provided on the second housing 102, and a hinge module (not illustrated). The center hinge arm 123 is coupled to the opposite ends or at least one end of the center hinge arm 123 between the side hinge arms 113 by the hinge module. As a result, the second housing 102 is pivotally coupled to the first housing 101.

The portable electronic device 100 may be provided with a sensing device 117 that senses whether the first and second housings 101 are 102 are opened or closed. For example, when the sensing device 117 senses the closed or folded state of the first and second housing 101 and 102, the portable electronic device 100 may be switched to a standby mode. When the sensing device 117 senses the opened or unfolded state, the portable electronic device 100 is switched to an activated mode. Of course, when it is desired by the user, it may be possible to set the standby mode and the activated mode to be manually switched.

According to an embodiment of the present invention, the sensing device 117 may be configured using a Hall sensor. The Hall sensor usually senses the direction and magnitude of an electromagnetic field. Thus, if the sensing device 117 is configured using a Hall sensor, the portable electronic device 100 may be provided with a magnet 127 which corresponds to the sensing device 117. In the embodiment illustrated in FIG. 1, a configuration in which the sensing device 117 is installed on the front side of the first housing 101, in other words, on the outer surface of the front case 101b is shown. The sensing device 117 may be positioned adjacent to the side hinge arms 113 and opened/closed by the second housing 102. In the embodiment illustrated in FIG. 1, if the sensing device 117 is configured using a Hall sensor, the magnet 127 corresponding to the sensing device 117 is installed on the second housing 102. Alternatively, the sensing device 117 may be installed on the second housing 102, and the magnet 127 may be installed on the first housing 101. In the state in which the first and second housings 101 and 102 are folded, the magnet 127 is positioned to face the sensing device 117, in other words, to face the Hall sensor. Accordingly, the sensing device 117 may sense the folded state of the first and second housings 101 and 102, and when the folded state of the first and second housings 101 and 102 is sensed, the portable electronic device 100 is switched to the standby mode.

According to another embodiment of the present invention, the sensing device 117 may be configured using a proximity sensor. In such a case, the sensing device may detect the state where the second housing 102 is folded to face the first housing 101 even if a separate magnet is not installed. When the sensing device 117 is configured using a proximity sensor, the sensing device 117 may be installed on either of the first and second housings 101 and 102. For example, when the sensing device 117 configured using a proximity sensor is installed on the first housing 101, it may be positioned on a surface which is opened/closed by the second housing 102.

According to yet another embodiment of the present invention, contact pieces may be installed on each of the first and second housings 101 and 102 such that the contact pieces may be connected with each other to generate an electrical signal when the first and second housings 101 and 102 are folded.

As mentioned above, the portable electronic device 100 includes a pair of antenna elements 131 and 133 installed in the first housing 101 and a switch element 137 configured to connect one of the antenna elements 131 and 133 to the transmission/reception circuit module 139 of the portable electronic device 100 so as to configure an antenna device which enables wireless transmission/reception. In the antenna elements, the first and second antenna elements 131 and 133 may be installed in the rear case 101a of the first housing 101 and the front case 101b of the first housing 101, respectively. The first antenna element 131 may be configured by a radiation pattern formed on the inner surface of the rear case 101a, for example, on the bottom surface or a side wall of the accommodation space 111. In the embodiment illustrated in FIG. 1, the first antenna element 131 is formed over the bottom surface and the side wall of the accommodation space 111 and positioned adjacent to the hinge device. The second antenna element 133 may be configured by a radiation pattern formed on the inner surface of the front case 101b. The second antenna element 133 may be formed on the inner surface of the front case 101b adjacent to the input device 115, more specifically, between the input device 115 and the hinge device. Accordingly, the second antenna element 133 may be positioned adjacent to the first antenna element 131. When forming the radiation patterns which form the first and second antenna elements 131 and 133, respectively, a metallic material may be deposited on each of the inner surfaces of the front and rear cases 101b and 101a or a metal sheet may be processed and attached to each of the inner surfaces of the front and rear cases 101b and 101a.

The switch element 137 selects one of the first and second antenna elements 131 and 133 depending on whether the first and second housings 101 and 102 are folded or unfolded and connects the selected one to the transmission/reception circuit module 139. As for such a switch element, a Single Pole Double Throw (SPDT) switch is useful.

The transmission/reception circuit module 139 is configured on a main circuit board mounted within the first housing 101. Since whether or not the first and second housings 101 and 102 are folded may be sensed by the sensing device 117, the switch element 137 is controlled by the sensing device 117. In other words, when the folded state of the first and second housings 101 and 102 is sensed by the sensing device 117, the switch element 137 connects the first antenna element 131 to the transmission/reception circuit module 139 by a signal generated by the sensing device 117. In such a case, when the unfolded state of the first and second housings 101 and 102 is sensed, the switch element 137 connects the second antenna element 133 to the transmission/reception circuit module 139.

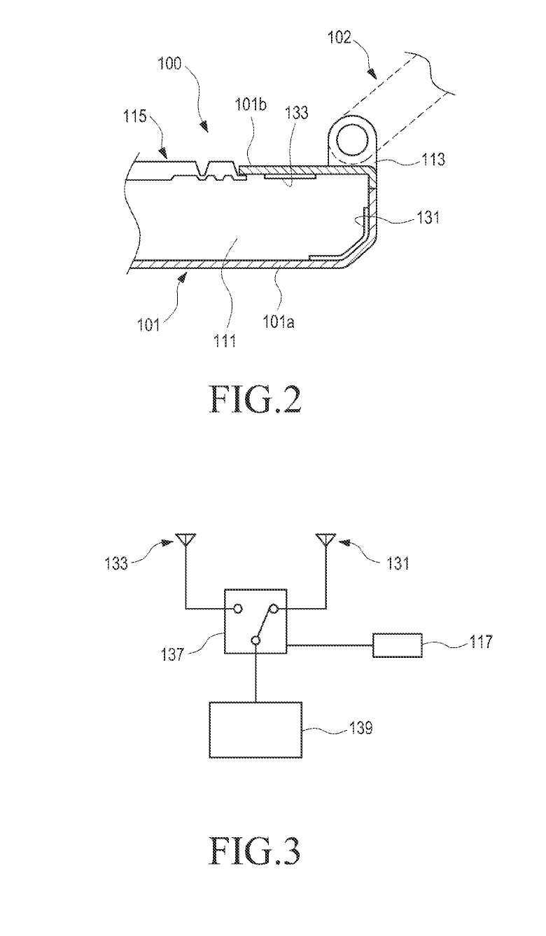

When using the portable electronic device 100, the first and second housing 101 and 102 are unfolded as illustrated in FIG. 2 and laid on a desk or similar surface. Typically, the first antenna element 131 installed on the rear case 101a is positioned to face a floor. Accordingly, there is difficulty in securing a stable radiation function with the first antenna element 131. On the contrary, the second antenna element 133 is positioned to face the top side of the portable electronic device 101 and the second housing 102 is in the state in which it is unfolded from the first housing 101. Thus, the second antenna element 133 may exhibit a more stable radiation function. Accordingly, when a signal is generated from the sensing device 117 which senses the unfolded state of the second housing 102, the switch element 137 connects the second antenna element 133 to the transmission/reception circuit module 139 so that the portable electronic device 100 may maintain the stable connection state with the wireless communication network.

Meanwhile, when the second housing 102 is folded to the first housing 101, the second antenna element 133 has difficulty in securing a stable radiation performance since it is covered by the second housing 102. When the portable electronic device is in the folded state, the first antenna element 131 is further opened toward the radiation space and thus may secure a better radiation performance. Thus, when a signal is generated from the sensing device 117 which senses the folded state of the second housing 102, the switch element 137 connects the first antenna element 131 to the transmission/reception circuit module 139. As a result, the portable electronic device 100 may maintain the stable connection state with the wireless communication network.

For example, for a portable electronic device 100 in which the second housing 102 may rotate 180 degrees before being folded onto the first housing 101, i.e., for a portable electronic device 100 which may operate in a tablet mode, the switch element 137 connecting the first antenna element 131 to the transmission/reception circuit module 139 will secure a more stable radiation performance when operating in the tablet mode.

As described above, the portable electronic device according to embodiments of the present invention is provided with antenna elements which are installed at different positions, respectively, and may connect an antenna element, which is capable of securing a good radiation performance according to the opened/closed state of the portable device, to the transmission/reception circuit module, using a switch. Such a portable electronic device may stably maintain the connection state with a wireless communication network regardless of whether the portable electronic device is opened or closed.

Accordingly, the normal connection state may be stably maintained by selecting an antenna element which is capable of securing a optimum radiation function according to the change in operation environment of the antenna device, for example, according to the positional change of the housings of the portable electronic device, and causing the selected antenna element to be operated.

In the above-described embodiments, an electrical switch, for example, an SPDT switch is referred to as the switch element. However, other switches such as a Double Pole Double Throw (DPDT) switch may be used. Further, the switch element may be configured using a physical switch in which contact devices are disposed between the center hinge arm and side hinge harms, respectively. Such a physical switch may cause the first antenna element 131 to contact with the transmission/reception circuit module 139 when the first and second housings are folded, and may cause the second antenna element 133 to contact with the transmission/reception circuit module 139 when the first and second housings are opened by a predetermined angle or more. More specifically, one contact device may be installed on the side hinge arms and connected with the transmission/reception circuit module, and first and second contact devices, which are respectively connected to the first and second antenna elements, may be installed on the center hinge arm. In such a case, the contact device installed on the side hinge arms may be disposed such that, in the state where the first and second housings are folded, the contact device comes into contact with the first contact device and in the state where the first and second housings are unfolded, the contact device comes into contact with the second contact device. When the switch element is configured by the physical switch in this manner, the switch element does not have to be linked to the sensing device.

Furthermore, when the portable electronic device includes two housings that are slidably connected to each other, when the housings are slid so as to be on top of each other in a closed state, a set of contact devices, with one contact device being located on the first housing 101 and a second contact device located on the second housing 102, align with each other to cause the first antenna element 131 to contact with the transmission/reception circuit module 139. When the housings are slid so as to be separated from each other in an open state, at least one additional contact device, located on the first housing 101, aligns with the contact device located on the second housing 102, to cause the second antenna element 133 to contact with the transmission/reception circuit module 139.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A portable electronic device comprising:
a first housing;
a second housing that is coupled to the first housing;
at least one pair of antenna elements that are housed in the first housing; and
a switch element that connects the antenna elements to a transmission/reception circuit module,
wherein the switch element connects a first antenna element to the transmission/reception circuit module when the first and second housings are folded on each other, and connects a second antenna element to the transmission/reception circuit module when the second housing is unfolded from the first housing.

2. The portable electronic device of claim 1, further comprising:
a sensing device that senses a folded or unfolded state of the first and second housings.

3. The portable electronic device of claim 2, wherein the sensing device is a Hall sensor installed on the first housing, and a magnet corresponding to the Hall sensor is installed on the second housing, and
wherein, when the first and second housings are folded on each other, the magnet is positioned to face the Hall sensor such that the Hall sensor senses the state where the second housing is folded on the first housing.

4. The portable electronic device of claim 2, wherein the sensing device is a Hall sensor installed on the second housing, and a magnet corresponding to the Hall sensor is installed on the first housing, and
wherein when the first and second housings are folded on each other, the magnet is positioned to face the Hall sensor such that the Hall sensor senses the state where the second housing is folded on the first housing.

5. The portable electronic device of claim 3, wherein the switch element is a single pole double throw switch that is operated when the Hall sensor senses whether the first and second housings are folded on each other.

6. The portable electronic device of claim 4, wherein the switch element is a single pole double throw switch that is operated when the Hall sensor senses whether the first and second housings are folded on each other.

7. The portable electronic device of claim 2, wherein the sensing device is a proximity sensor installed on the first housing, and the proximity sensor senses the state where the second housing is folded on the first housing.

8. The portable electronic device of claim 2, wherein the sensing device is a proximity sensor installed on the second housing, and the proximity sensor senses the state where the second housing is folded on the first housing.

9. The portable electronic device of claim 1, wherein the first housing includes a rear case that provides an accommodation space having an opened front side, and a front case that is coupled to the front side of the rear case to close the accommodation space, and the first and second antenna elements are installed on the rear case and the front case, respectively.

10. The portable electronic device of claim 9, wherein the first antenna element is a radiation pattern formed over a bottom surface and a lateral wall within the accommodation of the rear case.

11. The portable electronic device of claim 9, wherein the second antenna element is a radiation pattern formed on an inner surface of the front case.

12. The portable electronic device of claim 10, wherein the second antenna element is a radiation pattern formed on an inner surface of the front case.

13. The portable electronic device of claim 12, further comprising:
an input device formed on the front case,
wherein the second antenna element is positioned adjacent to the input device as well as adjacent to the first antenna element.

14. The portable electronic device of claim 13, wherein the input device is a key board.

15. The portable electronic device of claim 13, wherein the input device is a touch pad.

16. A portable electronic device comprising:
a first housing;
a second housing that is coupled to the first housing;
at least one pair of antenna elements that are housed in the first housing; and
a switch element that connects the antenna elements to a transmission/reception circuit module,
wherein the switch element connects a first antenna element to the transmission/reception circuit module when the first and second housings are located on top of each other, and connects a second antenna element to the transmission/reception circuit module when the second housing is not located on top of the first housing.

17. A portable electronic device comprising:
a first housing;
a second housing that is slidably coupled to the first housing;
at least one pair of antenna elements that are housed in the first housing; and
a switch element that connects the antenna elements to a transmission/reception circuit module,
wherein the switch element connects a first antenna element to the transmission/reception circuit module when the first and second housings are located on top of each other, and connects a second antenna element to the transmission/reception circuit module when the second housing is slid away from the first housing.
